(19) United States
(12) Patent Application Publication
(10) Pub. No.: US 2008/0196285 A1
(43) Pub. Date: Aug. 21, 2008

(54) ADVERTISING DISPLAY

(76) Inventor: Dwayne Klassen, Calgary (CA)

Correspondence Address: SMART AND BIGGAR, 438 UNIVERSITY AVENUE, SUITE 1500 BOX 111, TORONTO, ON, M5G2K8, CA

(21) Appl. No.: 11/934,371

(22) Filed: Nov. 2, 2007

Related U.S. Application Data
(63) Continuation of application No. 11/156,615, filed on Jun. 21, 2005, now abandoned.
(60) Provisional application No. 60/668,962, filed on Apr. 7, 2005.

(51) Int. Cl. G09F 1/10; G09F 1/00

(52) U.S. Cl. 40/124.06

(57) ABSTRACT

A cap has a recessed side wall which receives an indicia bearing card. A transparent plate covers the card. With this arrangement, the card is protected from the weather and may be swapped out for a different card. The cap may be configured to cap a wheel stop but may also be placed along the periphery of a tee-off box on a golf course. In the latter instance, spikes with golf-ball like heads may be used to moor the caps in place.

### CROSS-REFERENCE TO RELATED APPLICATION

This application claims the benefit of prior provisional application Ser. No. 60/668,962, filed Apr. 7, 2005, the contents of which are hereby incorporated herein by reference.

### BACKGROUND

This invention relates to a cover and system for displaying advertisements and to a method of advertising.

Many parking lots are provided with vehicle wheel stops which act to define the limit to which a vehicle may be pulled into a parking spot. Since vehicle wheel stops are seen by many who use the parking lot, it has been contemplated to provide advertising on wheel stops. For example, U.S. Pat. No. 6,481,921 to Fenimore discloses an advertising system wherein a plurality of open channels are notched into the bottom surface of a wheel stop. A cover shaped similarly to the wheel stop has opposed openings which, when the cover is placed over the wheel stop, align with the channels of the wheel stop. Struts extend through each pair of opposed openings and an aligned channel in order to join the cover to the wheel stop. A thin plastic advertising sheets is adhesively affixed to each of the two opposite sides of the cover.

A need remains for an improved manner of advertising in association with a wheel stop.

### SUMMARY OF INVENTION

A cap has a recessed side wall which receives an indicia bearing card. A transparent plate covers the card. With this arrangement, the card is protected from the weather and may be swapped out for a different card. The cap may be configured to cap a wheel stop but may also be placed along the periphery of a tee-off box on a golf course. In the latter instance, spikes with golf-ball like heads may be used to moor the caps in place.

Accordingly, the present invention provides a cover for displaying advertisements comprising: an integral cap having a top wall and a pair of side walls, said cap configured to cap a vehicle wheel stop; a first side wall of said pair of side walls having a recessed section extending between upper and lower peripheral sections, said recessed section recessed with respect to said peripheral sections, said recessed section defining a surface; a transparent plate extending over said surface, said plate received by said recessed section; an indicia bearing card sandwiched between said surface and said plate; said plate and card having a combined thickness no greater than a depth of said recessed section.

According to another aspect of the present invention, there is provided a system for displaying advertisements, comprising: an integral cap having a top wall and a pair of opposed side walls; each of said pair of side walls having: a recessed section extending between upper and lower peripheral sections, said recessed section recessed with respect to said peripheral sections, said recessed section defining a surface; a transparent plate extending over said surface, said plate received by said recessed section; an indicia bearing card sandwiched between said surface and said plate; said plate and card having a combined thickness no greater than a depth of said recessed section; said top wall having at least two mounting holes.

According to a further aspect of the present invention, there is provided a method of advertising comprising: placing at least two caps about a periphery of a tee-off box of a golf course; each of said caps having a top wall with at least two mounting holes and a pair of opposed indicia bearing side walls; anchoring each of said caps about said periphery of said tee-off box with at least two spikes, each spike terminating in a dimpled sphere resembling a golf ball such that an anchored cap has an appearance of at least two golf balls attached to said top wall.

Other features and advantages will be apparent from the following description in conjunction with the drawings.

### BRIEF DESCRIPTION OF THE DRAWINGS

In the figures which illustrate example embodiments of the invention,

FIG. 1 is a perspective view of a cap made in accordance with this invention shown above a wheel stop;

FIG. 1A is a perspective view of a the cap of FIG. 1 shown with a plurality of wheel stops;

FIG. 2 is an exploded perspective view of the cap of FIG. 1 and a wheel stop;

FIG. 3 is a side view of the cap of FIG. 1;

FIG. 4 is a cross-sectional view along the lines 4-4 of FIG. 3;

FIG. 5 is a perspective view of a cap made in accordance with another embodiment of this invention;

FIG. 6 is a magnified view of a portion of FIG. 5;

FIG. 7 is a schematic view illustrating a further embodiment of this invention; and

FIG. 7A is perspective view of a spike used in the embodiment of FIG. 7.

### DETAILED DESCRIPTION

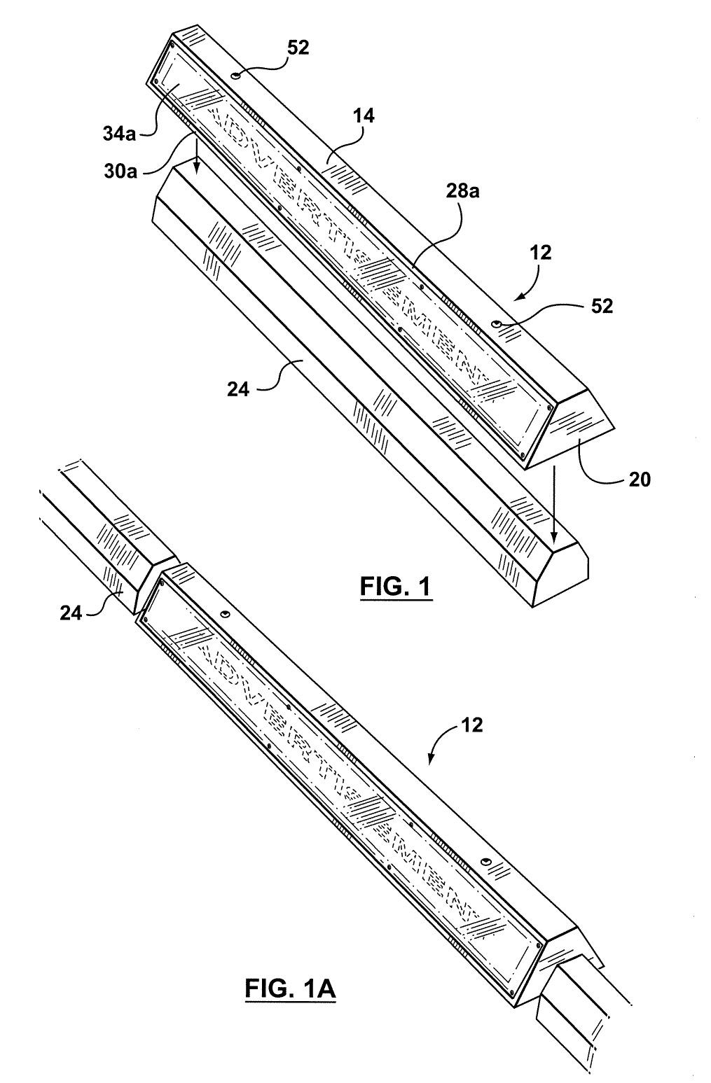

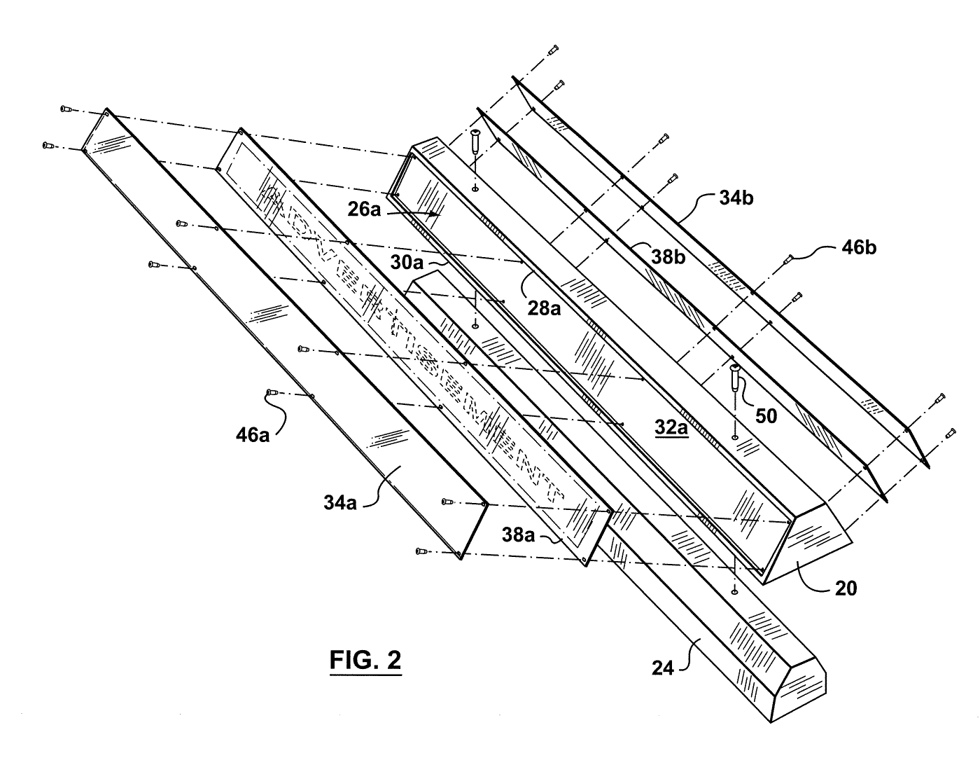

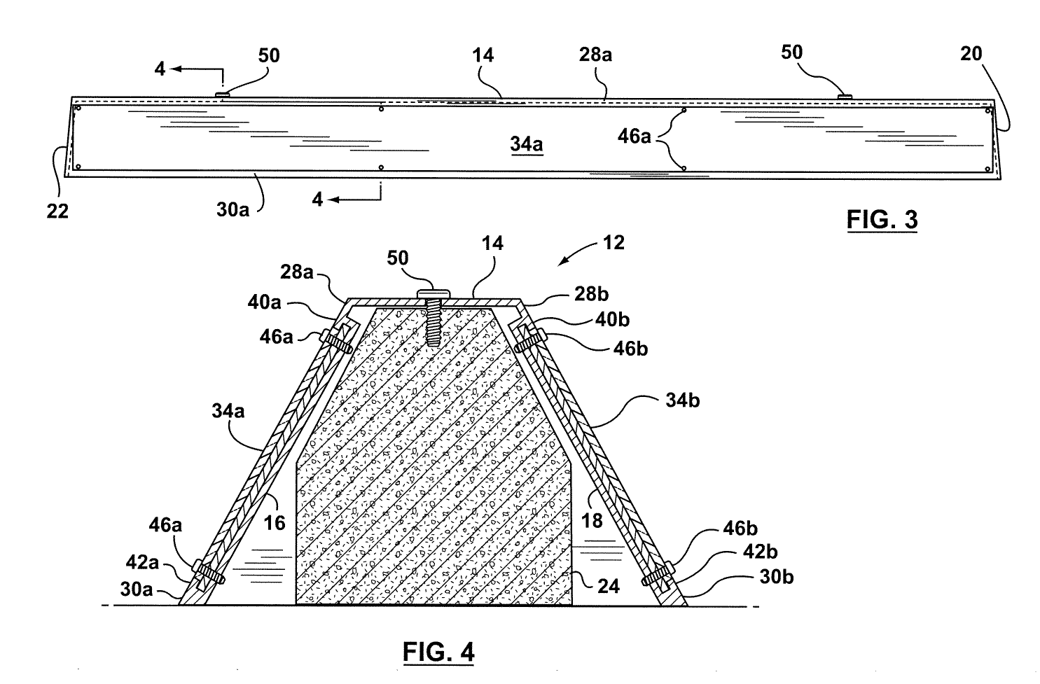

Turning to FIGS. 1 through 4, a cover for displaying advertisements is in the nature of an integral cap 12 with a top wall 14, first and second side walls 16, 18 and end walls 20, 22. The cap 12 is configured so that it can cap a vehicle wheel stop 24. The first side wall 16 has a recessed section 26a extending between upper and lower peripheral sections 28a, 30a, respectively. The recessed section is recessed with respect to the peripheral sections 28a, 30a and defines a surface 32a. A transparent plate 34a extends over the surface and is received by the recessed section. An indicia bearing card 38a is sandwiched between the surface 32a and the plate 34a.

With specific reference to FIG. 4, it will be apparent the plate and card have a combined thickness that is substantially equal to the depth of the recessed section such that the plate is substantially flush with the peripheral section. More generally, this combined thickness should not be greater than the depth of the recessed section 26a. It will also be apparent that the upper peripheral section 28a defines a downwardly opening upper channel and the lower peripheral section 30a defines an upwardly opening lower channel. The upper channel is partially defined by a downwardly extending lip 40a, which lip covers an upper margin of an outwardly facing surface of card 38a. Similarly, the lower channel is partially defined by an upwardly extending lip 42a, which lip covers a lower margin of the outwardly facing card surface.

A number of screws 46a extend through plate 34a and card 38a into the side 16 of the cap 12 in order to hold the plate and card in place on cap 12.

Side 18 of cap 12 is a mirror image of side 16 and like parts have been given like reference numerals, differentiated by the substitution of the letter “b”.

As is apparent from FIG. 4, cap 12 has a generally trapezoidal shape, with opposed side walls 16, 18 being of equal width.

Concrete screws 50 extend through mounting holes 52 (FIG. 1) in the top wall 14 of cap 12 into wheel stop 24.

As seen from FIG. 4, cap 12 has a height substantially the same as the height of wheel stop 24 and interior dimensions sufficient to accommodate the wheel stop.

The indicia bearing cards 38a, 38b may bear advertisements or other messages which may be visible when the wheel stop 24 is approached from either of its sides. Visibility is increased by virtue of the fact that the trapezoidal shape of the cap 12 angles cards 38a, 38b upwardly. The transparent plates 34a, 34b protect their respective cards 38a, 38b from water, snow, ice, dirt and dust. The plates may also provide UV protection. Thus, the cards, being protected from weather effects, can display their indicia for a considerable period of time without degradation. An advertisement, or other message, that remains vibrant is believed to be more compelling to the observer than one that appears worn.

To install a card at side 16 of cap 12, the lower margin of the card may be slipped behind lip 42a of the lower channel in side 16. The card may then be bowed so that its opposite margin slips behind lip 40a of the upper channel of side 16. The card is then held in place by these channels. Next the plate 34a is placed over the card and fastened in position by screws 46a. The described construction allows the indicia bearing cards 38 to be swapped out with different cards which may bear different indicia by simply reversing the afore-described operation.

Cards 38a, 38b may be fabricated of a flexible plastic, such as polystyrene. The transparent plates 34a, 34b may be fabricated of a hard plastic, such as LEXAN™.

Optionally, a rubber gasket may be provided between the inner end of the lips 40a, 42a and the edges of plate 34a to provide a tight seal that prevents moisture from seeping around the edges of the plate.

In an alternate embodiment, the side edges of one of the end walls 20 or 22 of cap 12 may be notched back so that the cards 38a, 38b may be slid into the channels of the side walls 16, 18. With this modification, the cards 38a, 38b do not need to be fabricated of a flexible material.

In an alternate embodiment, the width of the upper and lower channels partially defined by lips 40a, 40b, 42a, 42b may be increased to accommodate both a card 38a, 38b and a plate 34a, 34b. With this modification, upper lip 40a, 40b will prevent moisture from seeping around the upper edge of plate 34a, 34b. However, with this modification, either plate 34a, 34b must be made sufficiently flexible to allow insertion in the channels, or the side edges of one end wall 20, 22 of the cap 12 must be notched back so that the cards and plates may be slid into the channels.

While not shown, optionally, the top wall 14 may bear permanent indicia.

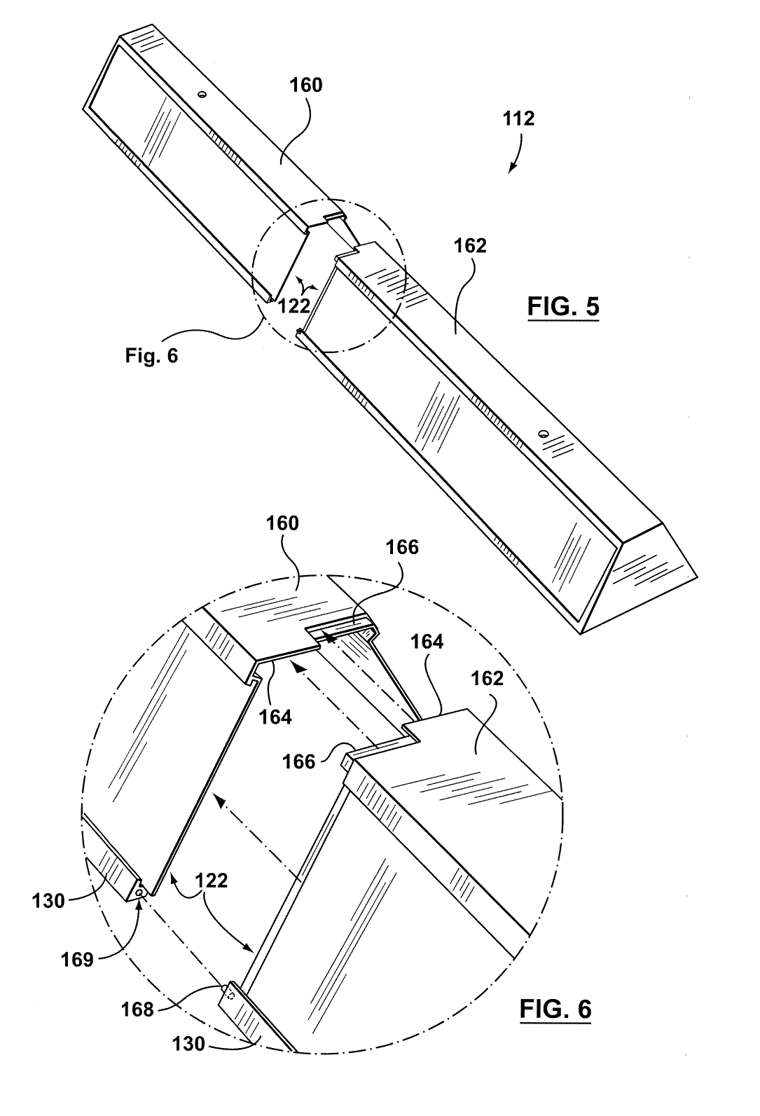

In a further embodiment illustrated in FIGS. 5 and 6, cap 112 has two sections: 160, 162, each of which is closed at an outer end 120 and open at an inner end 122. The open inner end 122 of each cap section 160, 162 has a projecting flange 164 and a notched ledge 166. Each of the lower peripheral margins 130 of the section 162 has a peg 168 that can be press fit into a bore 169 in each of the lower peripheral margins 130 of section 160. Apart from the pegs and bores, sections 160, 162 are identical such that when the inner ends 122 of the sections are pushed together, the flange 164 of one mates with the ledge 166 of the other while the pegs are press fit into the bores. This joins the two sections together. This embodiment may facilitate installation of the cap.

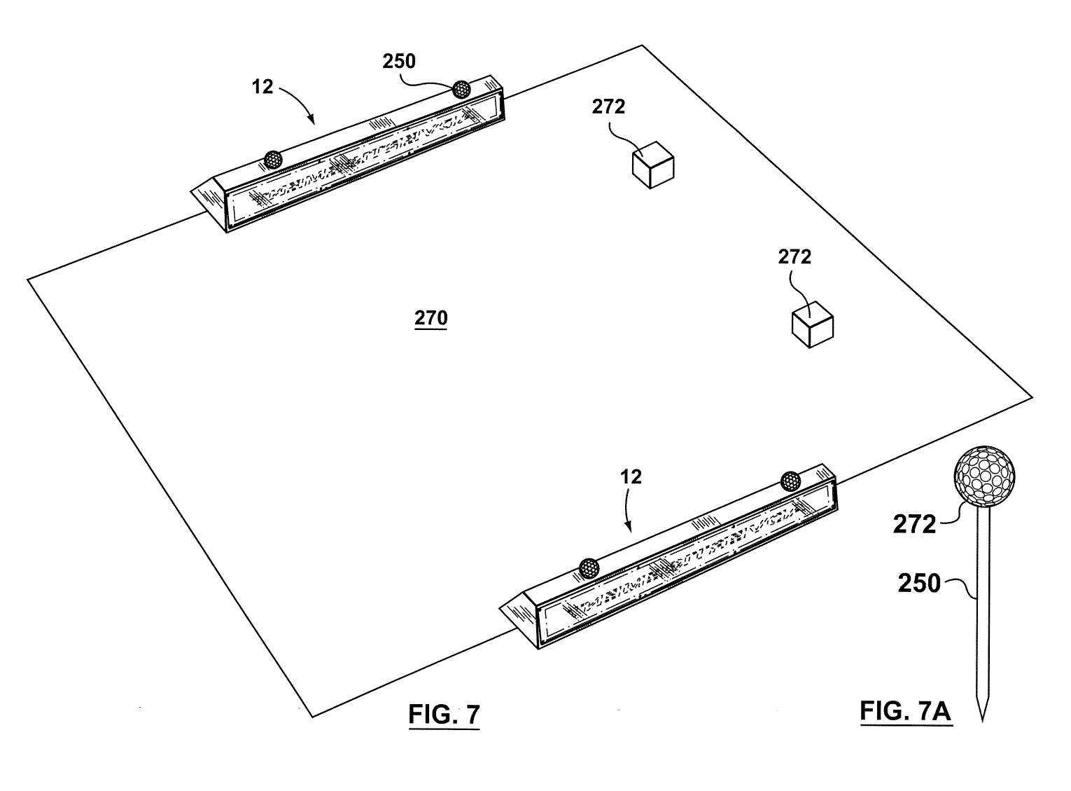

Turning to FIG. 7, a tee-off box 270 of a golf course may, as is conventional, have markers 272 to indicate a tee-off area. Two or more caps 12 may be set down along the periphery of the tee-off box 270 such that the longitudinal extent of each cap extends along the periphery of the tee-off box. In place of concrete screws 50 (FIG. 4), spikes 250 may driven into the ground through the mounting holes of the caps to moor the caps. With reference to FIG. 7A, each spike 250 may have a head 272 configured as a dimpled sphere so that the caps appear to be surmounted with golf balls. The indicia bearing cards of the caps may then provide appropriate messages to those who are teeing off from the box 270.

Other modifications will be apparent to those skilled in the art and, therefore, the invention is defined by the claims.

What is claimed is:

1. A cover for displaying advertisements comprising:
an integral cap having a top wall and a pair of side walls, said cap configured to cap a vehicle wheel stop;
a first side wall of said pair of side walls having a recessed section extending between upper and lower peripheral sections, said recessed section recessed with respect to said peripheral sections, said recessed section defining a surface;
a transparent plate extending over said surface, said plate received by said recessed section;
an indicia bearing card sandwiched between said surface and said plate;
said plate and card having a combined thickness no greater than a depth of said recessed section.

2. The cover of claim 1 wherein said upper peripheral section defines a downwardly opening upper channel and said lower peripheral section defines an upwardly opening lower channel.

3. The cover of claim 2 wherein said upper channel is partially defined by a downwardly extending lip, which lip, with said indicia bearing card sandwiched between said surface and said plate, covers an upper margin of an outwardly facing surface of said card.

4. The cover of claim 3 wherein a combined thickness of said card and said plate is substantially equal to said depth of said recessed section such that said plate is substantially flush with said peripheral section.

5. The cover of claim 4 wherein a second side wall of said pair of side walls extends opposite said first side wall, said first side wall and said second side wall having an equal width.

6. The cover of claim 5 wherein said second side wall has a second recessed section extending between upper and lower second peripheral sections, said second recessed section recessed with respect to said second peripheral sections, said second recessed section defining a second surface and further comprising:
a second side wall transparent plate extending over said second surface, said second plate received by said second recessed section;
a second indicia bearing card sandwiched between said second surface and said second plate, said second plate and second card having a combined thickness no greater than a depth of said second recessed section.

7. The cover of claim 6 wherein said upper second peripheral section defines a downwardly opening second upper channel and said second lower peripheral section defines an upwardly opening second lower channel.

8. The cover of claim 7 wherein said second upper channel is partially defined by a second downwardly extending lip, which second lip, with said second indicia bearing card sandwiched between said second surface and said second plate, covers an upper margin of an outwardly facing surface of said second card.

9. The cover of claim 5 wherein said cap has a generally trapezoidal profile, said first side and said second side comprising opposed sides of said trapezoidal profile.

10. The cover of claim 3 further comprising at least one fastener for fastening said plate over said surface.

11. The cover of claim 1 wherein said top wall has at least two mounting holes for receiving concrete screws.

12. The cover of claim 1 wherein said cap further comprises a pair of opposed end walls.

13. The cover of claim 1 wherein one end of said cap is closed and an opposite end of said cap is open.

14. The cover of claim 13 wherein said open end of said cap has a flange projecting in an end-to-end direction outwardly from said open end.

15. A system for displaying advertisements, comprising:
an integral cap having a top wall and a pair of opposed side walls;
each of said pair of side walls having:
a recessed section extending between upper and lower peripheral sections, said recessed section recessed with respect to said peripheral sections, said recessed section defining a surface;
a transparent plate extending over said surface, said plate received by said recessed section;
an indicia bearing card sandwiched between said surface and said plate;
said plate and card having a combined thickness no greater than a depth of said recessed section;
said top wall having at least two mounting holes.

16. The system of claim 15 further comprising at least two spikes for reception in said mounting holes, each of said spikes terminating in a dimpled sphere.

17. The system of claim 15 further comprising:
a concrete wheel stop covered by said cap;
a concrete screw extending through each of said mounting holes of said cap into said wheel stop.

18. A method of advertising comprising:
placing at least two caps about a periphery of a tee-off box of a golf course;
each of said caps having a top wall with at least two mounting holes and a pair of opposed indicia bearing side walls;
anchoring each of said caps about said periphery of said tee-off box with at least two spikes, each spike terminating in a dimpled sphere resembling a golf ball such that an anchored cap has an appearance of at least two golf balls attached to said top wall.

19. The method of claim 18 wherein each indicia bearing side wall of each cap has a recessed section extending between upper and lower peripheral sections, said recessed section recessed with respect to said peripheral sections, said recessed section defining a surface; a transparent plate extending over said surface, said plate received by said recessed section; and an indicia bearing card sandwiched between said surface and said plate.

20. The method of claim 19 wherein each cap is longitudinally elongated and wherein each cap is oriented with its longitudinal extent extending along said periphery of said tee-off box.
